(19) United States
(12) Patent Application Publication
(10) Pub. No.: US 2009/0305195 A1
(43) Pub. Date: Dec. 10, 2009

(54) PREFORMED MALLEABLE SOLID CROWN

(76) Inventors: Todd D. Jones, St. Paul, MN (US); Naimul Karim, Maplewood, MN (US); Dwight W. Jacobs, Hudson, WI (US); Kathleen A. Randolph, Mendota Heights, MN (US)

Correspondence Address: 3M INNOVATIVE PROPERTIES COMPANY, PO BOX 33427, ST. PAUL, MN, 55133-3427, US

(21) Appl. No.: 12/440,611

(22) PCT Filed: Sep. 10, 2007
(86) PCT No.: PCT/US07/78006

§ 371 Date: Aug. 5, 2009

Related U.S. Application Data
(60) Provisional application No. 60/825,482, filed on Sep. 13, 2006.

(51) Int. Cl. A61C 5/11; A61C 5/10

(52) U.S. Cl. 433/219; 433/223

(57) ABSTRACT

A solid dental crown and methods of using the solid dental crown are disclosed. The solid dental crown includes, a self-supporting solid hardenable preformed dental crown having an external crown shape defined by an external crown surface. The external crown surface defines a crown volume that is substantially filled with a hardenable composition. The hardenable composition has sufficient malleability so that the solid preformed dental crown can be pressed onto a prepared tooth surface to form a recess in the solid preformed dental crown defined by a recess surface that is complimentary to the prepared tooth surface.

### CROSS-REFERENCE TO RELATED APPLICATION

This application claims priority from U.S. Patent Application Ser. No. 60/825482, filed Sep. 13, 2006.

### BACKGROUND

The present disclosure relates generally to preformed malleable solid crowns used in restorative dentistry and methods of using the preformed malleable solid crowns.

Restorative dentistry is an important market in today's dental industry. In particular, tooth repair with temporary and permanent crowns is a common procedure, typically requiring multiple dental appointments. In many instances, practitioners rely on preformed dental crowns to expedite the restoration process by providing a dental crown in the shape of the tooth being restored.

Preformed crowns that are available in the market today are typically made of metals (e.g., stainless steel, aluminum, metal alloys, etc.) or polymers (e.g. polycarbonate, polyacetal, etc.). Metal crowns can additionally be covered with a tooth colored coating to provide an aesthetic appearance.

If adjustments to the preformed metal and polymer crowns are needed, they can be trimmed with a crown scissors, or other instruments to remove material at the crown margin to obtain a desired crown length. Metal crowns may also be crimped at the cervical region to obtain good marginal adaptation. Modification of other crown dimensions, however, such as interproximal distances, crown anatomy, etc. are not performed because the materials used in the preformed crowns are not amenable to shape adjustment by the practitioner. As a result, these crowns are offered in a very large number of sizes, typically 36 or more for either the posterior or anterior teeth, to sufficiently cover the range of conditions encountered in a dental practice.

These crowns must be lined with either composite or cement, for example, in order to fill the gaps between the interior of the crown and the surface of the prepared tooth. These liner materials often have weaker mechanical properties than the crown material. In addition, liner materials provide at least two interfaces for adhesive failure.

### SUMMARY

In one exemplary implementation, the present disclosure is directed to a solid dental crown. The solid dental crown includes, a self-supporting solid hardenable preformed dental crown having an external crown shape defined by an external crown surface. The external crown surface defines a crown volume that is substantially filled with a hardenable composition. The hardenable composition has sufficient malleability so that the solid preformed dental crown can be pressed onto a prepared tooth surface to form a recess in the solid preformed dental crown defined by a recess surface that is complimentary to the prepared tooth surface.

In another exemplary implementation, the present disclosure is directed to a method of using a self-supporting solid hardenable preformed dental crown. The method includes providing a self-supporting solid hardenable preformed dental crown having an external crown shape defined by an external crown surface, and pressing the self-supporting solid hardenable preformed dental crown onto a prepared tooth to form a recess in the solid preformed dental crown defined by a recess surface that is complimentary to the prepared tooth surface. The external crown surface defines a crown volume that is substantially filled with a hardenable composition prior or the pressing step.

These and other aspects of the preformed malleable solid crowns and method of using preformed malleable solid crowns according to the subject invention will become readily apparent to those of ordinary skill in the art from the following detailed description together with the drawings.

### BRIEF DESCRIPTION OF THE DRAWINGS

So that those having ordinary skill in the art to which the subject invention pertains will more readily understand how to make and use the subject invention, exemplary embodiments thereof will be described in detail below with reference to the drawings, in which:

FIG. 1 is a schematic cross-sectional diagram of one illustrative manufacturing process;

FIG. 2 is a schematic cross-sectional view of one illustrative solid dental crown;

FIG. 3 is a schematic cross-sectional view of another illustrative solid dental crown; and

FIGS. 4A-4D are schematic cross-sectional diagrams of one illustrative method of using the solid dental crown.

### DETAILED DESCRIPTION

This disclosure describes preformed solid crowns made of a malleable and hardenable material. The malleable and hardenable material can be cured to form a hard dental composite, suitable for long term use, i.e., from 2 weeks to more than 5 years, for example. The malleability of this solid crown allows for customization from the basic preformed shape. In many embodiments, the interior of this solid crown allows for accurate fit to dental preparations, particularly small dental preparations such as, for example, heavily reduced anterior teeth and pediatric preparations. Traditional preformed crowns have an exterior and interior surface that forms a relatively thin shell. The solid crowns described herein provide an interior surface that is complimentary to a prepared tooth, and in some embodiments the interior surface is in intimate contact with the prepared tooth.

Accordingly, the present disclosure is directed generally to preformed malleable solid crowns used in restorative dentistry and methods of using the preformed malleable solid crowns, and particularly to preformed malleable solid crowns that are substantially filled with a malleable hardenable composition that can form an inner crown surface that is complimentary to a prepared tooth. While the present invention is not so limited, an appreciation of various aspects of the invention will be gained through a discussion of the examples provided below.

The following description should be read with reference to the drawings, in which like elements in different drawings are numbered in like fashion. The drawings, which are not necessarily to scale, depict selected illustrative embodiments and are not intended to limit the scope of the disclosure. Although examples of construction, dimensions, and materials are illustrated for the various elements, those skilled in the art will recognize that many of the examples provided have suitable alternatives that may be utilized.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

The term “self-supporting” as used herein means that each crown is dimensionally stable and will maintain its preformed shape without significant deformation at room temperature (i.e., about 20° C. to about 25° C.) for at least about two weeks when free-standing (i.e., without the support of packaging or a container). In many embodiments, the preformed solid dental crowns described herein are dimensionally stable at room temperature for at least about one month, or for at least about six months. In some embodiments, the preformed solid dental crowns described herein are dimensionally stable at temperatures above room temperature, or up to about 40° C., or up to about 50° C., or up to about 60° C. This definition applies in the absence of conditions that activate any initiator system and in the absence of an external force other than gravity.

The term “sufficient malleability” means that the self-supporting preformed solid dental crown is capable of being custom-shaped and fitted onto a prepared tooth under a moderate manual force (i.e., a force that ranges from light finger pressure to that applied with manual operation of a small hand tool, such as a dental composite instrument). The shaping, fitting, forming, etc., can be performed by adjusting the external shape and internal cavity shape of the preformed solid dental crown.

In many embodiments, the preformed solid dental crowns described herein consist essentially of a hardenable composition. The hardenable compositions used in preformed solid dental crowns described herein may exhibit the desired “sufficient malleability” at temperatures of, e.g., 40 degrees Celsius or less. In other instances, the hardenable compositions may exhibit “sufficient malleability” in a temperature range of, e.g., 15° C. to 38° C.

In many embodiments, the hardenable compositions of the preformed solid dental crowns described herein are “irreversibly hardenable” which, as used herein, means that after hardening such that the composition loses its malleability it cannot be converted back into a malleable form without destroying the external shape of the solid dental crown.

Examples of some potentially suitable hardenable compositions that may be used to construct the preformed solid dental crowns described herein with sufficient malleability may include, e.g., hardenable organic compositions (filled or unfilled), polymerizable dental waxes, hardenable dental compositions having a wax-like or clay-like consistency in the unhardened state, etc. In some embodiments, the preformed solid dental crowns are constructed of hardenable compositions that consist essentially of non-metallic materials.

Potentially suitable hardenable compositions that may be used to manufacture the preformed solid dental crowns of the present invention may be described in U.S. Patent Application Publication No. US 2003/0114553, titled HARDENABLE SELF-SUPPORTING STRUCTURES AND METHODS (Karim et al.). Other suitable hardenable compositions may include those described in U.S. Pat. No. 5,403,188 (Oxman et al.); U.S. Pat. No. 6,057,383 (Volkel et al.); and U.S. Pat. No. 6,799,969 (Sun et al.).

With respect to the hardenable compositions described in US 2003/0114553, the unique combination of highly malleable properties (preferably without heating above room temperature or body temperature) before hardening (e.g., cure) and high strength (preferably, e.g., a flexural strength of at least about 25 MPa) after hardening may provide preformed solid dental crowns with numerous potential advantages.

As discussed herein, the preformed solid dental crowns hardenable compositions that are sufficiently malleable to facilitate forming of preformed solid dental crowns onto a prepared tooth during the fitting process. Because the compositions are hardenable, the adjusted external shape can be retained.

As described above, useful hardenable compositions for the preformed solid dental crowns described herein may include, e.g., polymerizable waxes, hardenable organic materials (filled or unfilled), etc. Some potentially suitable hardenable compositions may include those described in U.S. Pat. No. 5,403,188 (Oxman et al.); U.S. Pat. No. 6,057,383 (Volkel et al.); and U.S. Pat. No. 6,799,969 (Sun et al.). Other hardenable compositions that may be used to manufacture the preformed solid dental crowns described herein may be described in U.S. Patent Application Publication No. US 2003/0114553, titled HARDENABLE SELF-SUPPORTING STRUCTURES AND METHODS (Karim et al.). As described therein (and briefly summarized in the following discussion), a hardenable composition of US 2003/0114553 may include a resin system that includes a crystalline component, greater than 60 percent by weight (wt-%) of a filler system (preferably, greater than 70 wt-% of a filler system), and an initiator system, wherein the hardenable composition exhibits sufficient malleability to be formed onto a prepared tooth, preferably at a temperature of about 15° C. to 38° C. (more preferably, about 20° C. to 38° C., which encompasses typical room temperatures and body temperatures). In some embodiments, the hardenable compositions do not need to be heated above body temperature (or even about room temperature) to become malleable as discussed herein.

In many embodiments, at least a portion of the filler system of the hardenable compositions of US 2003/0114553 includes particulate filler. In this and various other embodiments, if the filler system includes fibers, the fibers are present in an amount of less than 20 wt-%, based on the total weight of the composition.

The crystalline component may provide a morphology that assists in maintaining the self-supporting first shape. This morphology includes a noncovalent structure, which may be a three-dimensional network (continuous or discontinuous) structure. If desired, the crystalline component can include one or more reactive groups to provide sites for polymerizing and/or crosslinking. If such crystalline components are not present or do not include reactive groups, such reactive sites are provided by another resin component, such as an ethylenically unsaturated component.

Thus, for certain embodiments, the resin system includes at least one ethylenically unsaturated component. Ethylenically unsaturated components can be selected from the group consisting of mono-, di-, or poly-acrylates and methacrylates, unsaturated amides, vinyl compounds (including vinyl oxy compounds), and combinations thereof. This ethylenically unsaturated component can be the crystalline component or noncrystalline.

The crystalline component can include polyesters, polyethers, polyolefins, polythioethers, polyarylalkylenes, polysilanes, polyamides, polyurethanes, or combinations thereof. The crystalline component can include saturated, linear, aliphatic polyester polyols containing primary hydroxyl end groups. The crystalline component can optionally have a dendritic, hyperbranched, or star-shaped structure, for example.

The crystalline component can optionally be a polymeric material (i.e., a material having two or more repeat units, thereby including oligomeric materials) having crystallizable pendant moieties and the following general formula:

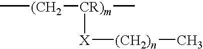

wherein R is hydrogen or a (C₁-C₄)alkyl group, X is —CH₂—, —C(O)O—, —O—C(O)—, —C(O)—NH—, —HN—C(O)—, —O—, —NH—, —O—C(O)—NH—, —HN—C(O)—O—, —HN—C(O)—NH—, or —Si(CH₃)₂—, m is the number of repeating units in the polymer (preferably, 2 or more), and n is great enough to provide sufficient side chain length and conformation to form polymers containing crystalline domains or regions.

Alternative to, or in combination with, the crystalline component, the hardenable composition can include a filler that is capable of providing a morphology to the composition that includes a noncovalent structure, which may be a three-dimensional network (continuous or discontinuous) structure, that assists in the maintenance of the first shape. In some embodiments, such a filler has nanoscopic particles, or the filler is an inorganic material having nanoscopic particles. To enhance the formation of the noncovalent structure, the inorganic material can include surface hydroxyl groups. In some embodiments, the inorganic material includes fumed silica.

Furthermore, the use of one or more surfactants can also enhance the formation of such a noncovalent structure. In some embodiments, the composition includes, in addition to a resin system and an initiator system, either a crystalline component, or a filler system that includes a nanoscopic particulate filler (both a micron-size particulate filler and a nanoscopic particulate filler) and a surfactant system, or both a crystalline component and a filler system and surfactant system. As used herein, a filler system includes one or more fillers and a surfactant system includes one or more surfactants.

Another potential embodiment of the hardenable compositions that may be used in the preformed solid dental crowns of the invention may include a hardenable composition of US 2003/0114553 that includes a resin system, a filler system at least a portion of which is an inorganic material having nanoscopic particles with an average primary particle size of no greater than about 50 nanometers (nm), a surfactant system, and an initiator system. The hardenable composition can exhibit sufficient malleability to be formed onto a prepared tooth at a temperature of about 15° C. to 38° C. In embodiments with a surfactant system and nanoscopic particles, the resin system can include at least one ethylenically unsaturated component, and the filler system is present in an amount of greater than 50 wt-%.

In other potentially preferred embodiments, hardenable compositions may include a resin system that includes: a noncrystalline component selected from the group consisting of mono-, di-, or poly- acrylates and methacrylates, unsaturated amides, vinyl compounds, and combinations thereof; and a crystalline component selected from the group consisting of polyesters, polyethers, polyolefins, polythioethers, polyarylalkylenes, polysilanes, polyamides, polyurethanes, polymeric materials (including oligomeric materials) having crystallizable pendant moieties and the following general formula:

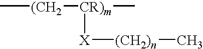

wherein R is hydrogen or a (C₁-C₄)alkyl group, X is —CH₂—, —C(O)O—, —O—C(O)—, —C(O)—NH—, —HN—C(O)—, —O—, —NH—, or —O—C(O)—NH—, —HN—C(O)—O—, —HN—C(O)—NH—, or —Si(CH₃)₂—, m is the number of repeating units in the polymer (preferably, 2 or more), and n is great enough to provide sufficient side chain length and conformation to form polymers containing crystalline domains or regions, and combinations thereof. The hardenable composition further includes greater than about 60 wt-% of a filler system and an initiator system. The hardenable composition can exhibits sufficient malleability to be formed onto a prepared tooth at a temperature of about 15° C. to 38° C. If the filler system includes fibers, the fibers may be present in an amount of less than 20 wt-%, based on the total weight of the hardenable composition.

In yet another embodiment, the hardenable compositions includes a resin system with a crystalline compound of the formula:

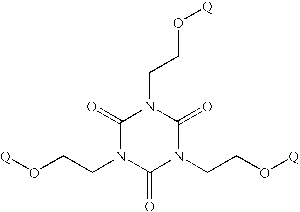

wherein each Q independently comprises polyester segments, polyamide segments, polyurethane segments, polyether segments, or combinations thereof; a filler system; and an initiator system.

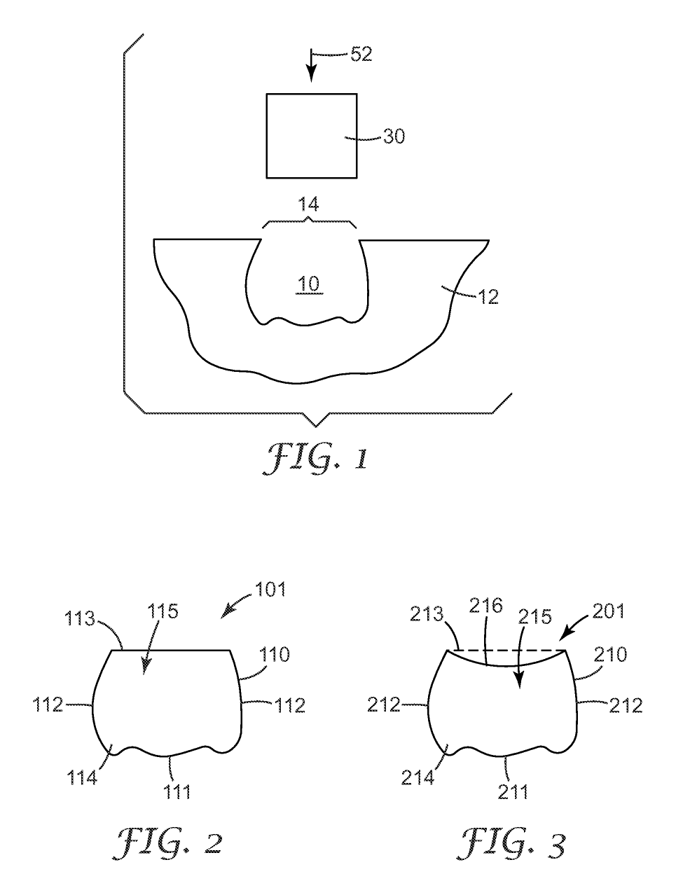

FIG. 1 is a schematic cross-sectional diagram of one illustrative manufacturing process. The illustrated process includes a mold cavity 10 formed in a body 12. The mold cavity 10 includes an opening 14 leading to the volume of the mold cavity itself, which is depicted in cross-section in FIG. 1. In the depicted embodiment, the mold cavity 10 is in the shape of a molar dental crown. It should, however, be understood that the mold cavity 10 can have any dental crown shape to mimic, for example, an incisor, canine, pre-molar, or molar.

The mold body 12 may be formed in any suitable material or combination of materials, e.g., metals, polymeric materials, etc. that provide sufficient structural integrity to withstand the forming process as described herein. In some instances, the mold body 12 may be formed in separable sections to facilitate removal of a solid dental crown formed therein. Also, the mold body 12 may be made of or coated with a material adapted to aid release of the dental crown from the interior surfaces of the mold cavity 10. For example, the interior surfaces of the mold cavity 10 may be coated with, e.g., fluorinated polymers (e.g., PTFE, etc.), boron carbide, chrome, thin dense chrome, chromium nitride, electroless nickel infused with fluorinated polymers, modified tungsten disulfide (e.g., DICRONITE), etc.

In other variations, the mold cavity 10 may be temperature controlled to assist in the molding process by, e.g., heating and/or cooling the temperature of the interior surfaces of the mold cavity 10. In yet other variations, the mold cavity 10 may be vented or evacuated during the molding process to enhance molding. Ultrasonic or other vibrational energy may also be used to enhance filling of the mold cavity 10 and/or assist with release the article from the mold cavity 10.

A mass of hardenable dental material 30 is disposed adjacent to the opening 14 into the mold cavity 10. The mass of hardenable dental material 30 is disposed into the mold cavity 10 through the opening 14 therein. As a result, the mass of hardenable dental material 30 are advanced in the direction of arrow 52 as depicted in FIG. 1.

The mass of hardenable dental material 30 can be pre-formed into a shape suitable for molding into the desired finished solid dental crown. The hardenable dental material 30 can be provided in the shape of, e.g., a circular cylinder, circular cone, rectangular prism, spherical pellet, etc.

The process illustrated in FIG. 1 can be described as a compression molding process. It should, however, be understood that the hardenable dental material 30 may be formed into the shape of the hardenable dental article by any suitable process. Some suitable processes may include, but are not limited to, e.g., injection molding, forging, casting, vacuum forming, extrusion molding, thermoforming, transfer molding, blow molding, etc.

In some embodiments, a mold liner (not shown) is disposed between the mold cavity 10 body 12 and the mass of hardenable dental material 30. An optional top liner (not shown) can be disposed on the base of the solid dental crown such that the solid dental crown is disposed between the mold liner and the top liner. These two liners can provide a packaging for the solid dental crown until it is used.

The mold liner and top liner can be constructed of a variety of different materials. For example, these liners can be manufactured of a deformable material that may be provided in sheet form over the opening 14 of the mold cavity 10 and deformed under the molding conditions (e.g., temperature, pressure, etc.) used to form the hardenable dental material 30 into the desired shape. Examples of some suitable materials for the liners can include, but are not limited to, e.g., polypropylenes, polyethylenes, polyurethanes, vinyls, thermoplastic elastomers, elastomeric films (e.g., rubber, latex, etc.), fluorinated polymers (e.g., FEP, PFA, THV, ECTFE, etc.), plasticized PVC, elastic-plastic films (e.g., blends of, for example, block copolymers of styrene and butadiene, and polypropylene), olefinic copolymers, copolymers (e.g., selected from copolymers of ethylene with vinyl acetate, and copolymers of ethylene with ionomers, available under the tradename Surlyn from DuPont Chemical (Wilmington, Del.), water soluble polymers (e.g., selected from the group consisting of polyvinylpyrrolidones, polyvinylpyrrolidone/vinyl acetate copolymers, polyvinyl alcohols, polyethylene oxides, polyacrylamides, polyacrylic acids, polysaccharides and synthetically modified polysaccharides (e.g., cellulose ether polymers), alginates (e.g., sodium alginate), polyethyl oxazolines, esters of polyethylene oxide, esters of polyethylene oxide and polypropylene oxide copolymers, urethanes of polyethylene oxide, urethanes of polyethylene oxide and polypropylene oxide copolymers, etc.). Further, these liners can include one or more coatings (e.g., silicone, etc.) to enhance formability, release from the hardenable dental crown, etc.

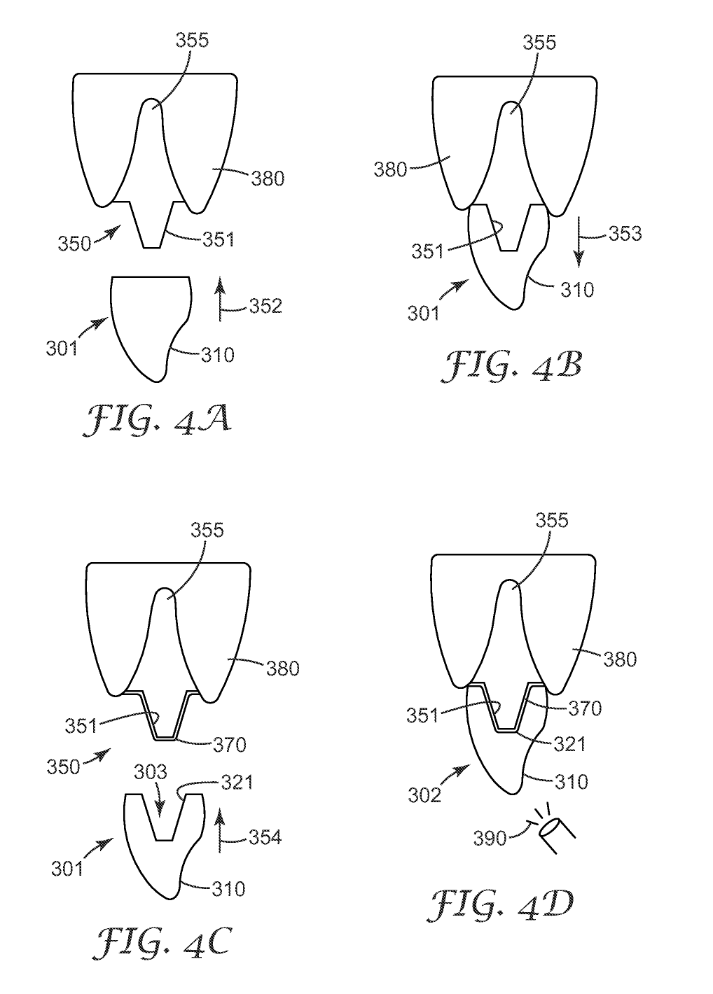

After removing the hardenable dental material 30 from the mold cavity 10, the now molded solid dental crown (depicted in FIGS. 2 and 3) are ready to be used (depicted in FIGS. 4A-4D) by a clinician once it is removed from any packaging (e.g. liners).

FIG. 2 is a schematic cross-sectional view of one illustrative solid dental crown 101. The solid dental crown 101 is also referred to as a self-supporting solid hardenable preformed dental crown 101. The solid dental crown 101 has an external crown shape defined by an external crown surface 110. The external crown surface 110 defines a crown volume 115. The crown volume 115 is substantially filled with the hardenable composition, as described above.

This hardenable composition has sufficient malleability such that the solid preformed dental crown can be pressed onto a prepared tooth surface to form a recess in the base 113 of the preformed crown such that a recess is formed into the base 113 of the preformed crown that is complimentary to the prepared tooth surface (see FIGS. 4A-4D). In the depicted embodiment, the preformed crown 101 is in the shape of a molar. It should, however, be understood that the preformed crown 101 can have any crown shape to mimic, for example, an incisor, canine, pre-molar, or molar. In the depicted embodiment, a buccal or lingual view (molar or pre-molar) is illustrated. For a canice or incisor this view would be a facial or lingual view.

The external crown surface 110 includes all exterior sides of the solid dental crown 101. The external crown surface 110 includes mesial and distal surfaces 112, buccal and lingual surfaces 114, an occlusal or incisal surface 111 and a gingival margin 113 that corresponds to a flat or planar surface or base surface. In this illustrated embodiment, the crown volume is 100 percent filled with the hardenable composition.

FIG. 3 is a schematic cross-sectional view of another illustrative solid dental crown 201. The solid dental crown 201 is also referred to as a self-supporting solid hardenable preformed dental crown 201. The solid dental crown 201 has an external crown shape defined by an external crown surface 210. The external crown surface 210 defines a crown volume 215. The crown volume 215 is substantially filled with the hardenable composition, as described above.

This hardenable composition has sufficient malleability such that the solid preformed dental crown can be pressed onto a prepared tooth surface to form a recess in the base 213 of the preformed crown such that a recess is formed into the base 213 of the preformed crown that is complimentary to the prepared tooth surface (see FIGS. 4A-4D). In the depicted embodiment, the preformed crown 201 is in the shape of a molar. It should, however, be understood that the preformed crown 201 can have any crown shape to mimic, for example, an incisor, canine, pre-molar, or molar. In the depicted embodiment, a buccal or lingual view (molar or pre-molar) is illustrated. For a canice or incisor this view would be a facial or lingual view.

The external crown surface 210 includes all exterior sides of the solid dental crown 201. The external crown surface 210 includes mesial and distal surfaces 212, buccal and lingual surfaces 214, an occlusal surface 211 and a gingival margin 213 that corresponds to a planar surface or base surface (shown as a broken line) that extends across the top of the gingival margin 213. In this embodiment, a concave recess 216 is inside the gingival margin 213. In this illustrated embodiment, the crown volume is 90 to 95 percent filled with the hardenable composition. In other embodiments, the recess 216 extends further into the solid crown 201 so that the crown volume is substantially filled with hardenable material (i.e, from 50 to 100 percent filled. In further embodiments, the recess 216 extends further into the solid crown 201 so that the crown volume is 60 to 100 percent, or 70 to 100 percent, or 80 to 100 percent, or 90 to 100 percent, or 95 to 100 percent filled with hardenable material, as desired.

FIGS. 4A-4D are schematic cross-sectional diagrams of one illustrative method of using the solid dental crown. In the depicted method, a solid incisor crown 301 is utilized. It should, however, be understood that the solid crown 301 can have any crown shape (defined by the external crown surface 310, as described above) to mimic, for example, an incisor, canine, pre-molar, or molar. In addition, the illustrated solid crown 301 has a flat base, similar to the solid crown shown in FIG. 2. It should, however, be understood that the solid crown can have a concave recess inside the crown gingival margin, similar to the solid crown shown in FIG. 3, or can be substantially filled with hardenable material, or be 80 to 100 percent or 90 to 100 percent, or 95 to 100 percent filled with hardenable material, as discussed above.

The solid crown 301 is advanced in the direction of arrow 352 as depicted in FIG. 4A and pressed onto a prepared tooth 350 having a prepared tooth surface 351 to form a recess 303 in the solid dental crown 301. The recess 303 is defined by a recess surface 321 that is complimentary to the prepared tooth surface 351. The prepared tooth includes a tooth root 355 disposed within gingiva 380. In many embodiments, the recess surface 321 is in intimate contact with the prepared tooth surface 351. Thus, the recess surface 321 forms a shape that is independent of the external crown surface 310.

Once the recess surface 321 is formed the solid crown 301 is removed from the prepared tooth 350 in the direction of arrow 353 as depicted in FIG. 4B. In some embodiments, the solid crown can be cured (i.e. hardened) or partially cured (via radiation or heat) before the solid crown 301 is removed from the prepared tooth 350. In many embodiments, the solid crown recess surface 321 does not adhere to the prepared tooth surface 351. In many embodiments, the solid crown recess surface 321 consists essentially of the hardenable material, described above.

As shown in FIG. 4C, an adhesive or cement layer 370 is disposed on the prepared tooth surface 351. It should, however, be understood that the adhesive or cement layer 370 can be disposed on the recess surface 321 or both the recess surface 321 and the prepared tooth surface 351, as desired. The solid crown 301 is advanced in the direction of arrow 354 as depicted in FIG. 4C and placed onto the prepared tooth surface 350 such that the adhesive or cement layer 370 is disposed between the prepared tooth surface 351 and the recess surface 321 to form an adhered crown.

The adhered crown can then be fitted, trimmed and cured with a radiation source 390, if necessary, to form a hardened dental crown 302. In some embodiments, the solid crown external shape can be altered, to form an altered external crown shape, during the fitting process, as desired. The preformed malleable solid crown exterior surface can be reshaped to customize and adapt to adjacent proximal contacts, occlusal and incisal contacts.

The preformed malleable solid crown described herein can be have any useful size or shape. In some instances, a number of these preformed malleable solid crowns can form a kit such that an end user could choose an appropriate size and shape for the desired application.

All the patents and patent applications identified above are incorporated by reference to the extent they do not conflict with the present disclosure. The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the instant specification.

### Examples

Unless otherwise noted, all reagents and solvents were or can be obtained from Sigma-Aldrich Corp., St. Louis Mo.

As used herein,

“bisGMA” refers to 2,2-bis[4-(2-hydroxy-3-methacryloyloxypropoxy)phenyl]propane;

“TONE-IEM” refers to the reaction product of TONE 0230 (a polycaprolactone polyol available from The Dow Chemical Co., Midland, Mich.) and 2-isocyanatoethyl methacrylate (available from Sigma-Aldrich Corp., St. Louis, Mo.), as described in U.S. Pat. No. 6,506,816;

“CABOSIL M-5” refers to a fumed silica available under the trade designation CAB-O-SIL M-5 from Cabot Corp., Boston, Mass.;

“TPEG-990” refers to a CARBOWAX trifunctional polyethylene glycol, available from The Dow Chemical Co., Midland, Mich.;

“FILLER A” refers to a silica-zirconia filler prepared essentially as described in U.S. Pat. No. 6,030,606, and having an average particle size of approximately 0.6 micrometer.

### Preparative Example 1

### Preparation of a Curable Malleable Dental Composition

A mixture of bisGMA (2.744 g), TONE-IEM (1.476 g), CABOSIL M-5 (0.146 g), TPEG 990 (0.114 g), and Filler A (14.484 g), having, based on the combined weights of the bisGMA and TONE-IEM, 1.49 weight percent benzotriazole, 0.17 weight percent camphorquinone, 0.99 weight percent ethyl 4-N,N-dimethylaminobenzoate, 0.15 weight percent buylated hydroxytoluene, and 0.5 weight percent diphenyliodonium hexafluorophosphate (available from Alfa Aesar, Ward Hill, Mass.), was heated at approximately 85° C. for approximately 20 minutes and was then mixed three times for one minute each using a Model DAC 150 FVZ SpeedMixer (manufactured by FlackTek, Inc., Landrum, SC) at 3000 rpm to afford a curable malleable dental composition

### Example 1

### Preparation of a Curable Malleable Solid Crown Having a Flat Base

An impression of a polycarbonate maxillary right central incisor crown (No. 100, available from 3M ESPE Dental Products, St. Paul, Minn.) was made using IMPRINT II vinyl polysiloxane impression material (available from 3M ESPE Dental Products, St. Paul, Minn.). The polycarbonate crown was then removed from the set impression material to provide a mold for forming the solid curable malleable solid crown. Approximately 5-millimeter long slits were cut through the base of the mold (the marginal edge of the crown) on opposite sides along the mesial-distal line using a razor blade. After the dental composition of Preparative Example 1 was heated in an oven at approximately 80° C. for approximately five minutes, the mold was filled with the dental composition. The base of the filled mold was then pressed against a flat surface to provide a molded solid curable malleable crown with a flat base. Excess dental composition was trimmed from the filled mold using a razor blade. The filled mold was placed in a refrigerator at a temperature of approximately 4° C. for approximately one hour, and then the mold was peeled off of the molded dental composition to afford a curable malleable solid crown having a flat base. The curable malleable solid crown was placed on a prepared central incisor model in a typodont and was shaped using conventional composite shaping instruments to provide customized shape and fit in the typodont. The curable malleable crown was partially cured by irradiating it for approximately three seconds with a ELIPAR FREELIGHT 2 LED CURING LIGHT (available from 3M ESPE Dental Products, St. Paul, Minn.), then it was removed from the typodont and further cured by irradiating it for approximately 60 seconds with the ELIPAR FREELIGHT 2. The cured crown was then placed on the prepared central incisor model in the typodont and was found to have an intimate fit with the prepared incisor model.

### Example 2

### Preparation of a Curable Malleable Solid Crown Having a Concave Base

An impression of a polycarbonate maxillary right central incisor crown was prepared essentially as described in Example 1 to provide a mold for forming the solid curable malleable solid crown. After the dental composition of Preparative Example 1 was heated in an oven at approximately 80° C. for approximately five minutes, the mold was filled with the dental composition. A concave base was formed in the dental composition in the mold by pressing the base of the filled mold against the 4-millimeter diameter end of a tapered rod that was made from a vinyl polysiloxane putty dental impression material (available under the trade designation “EXPRESS STD” from 3M ESPE Dental Products, St. Paul, Minn.). Excess dental composition was trimmed from the filled mold using a razor blade. The filled mold was placed in a refrigerator at a temperature of approximately 4° C. for approximately one hour, and then the mold was peeled off of the molded dental composition to afford a curable malleable solid crown having a concave base. The curable malleable solid crown was placed on a prepared central incisor model in a typodont and was shaped using conventional composite shaping instruments to provide customized shape and fit in the typodont. The curable malleable crown was partially- and then fully cured using the procedure essentially as described in Example 1. The cured crown was then placed on the prepared central incisor model in the typodont and was found to have an intimate fit with the prepared incisor model.

1-20. (canceled)

21. A solid dental crown comprising:
a self-supporting solid hardenable preformed dental crown having an external crown shape defined by an external crown surface, the external crown surface defining a crown volume being substantially filled with a hardenable composition;
wherein the hardenable composition has sufficient malleability such that the solid preformed dental crown can be pressed onto a prepared tooth surface to form a recess in the solid preformed dental crown defined by a recess surface that is complimentary to the prepared tooth surface.

22. A solid dental crown according to claim 21 wherein the external crown shape is selected from the group consisting of incisor, canine, pre-molar, and molar,

23. A solid dental crown according to claim 21 wherein the self-supporting solid hardenable preformed dental crown consists essentially of the hardenable material.

24. A solid dental crown according to claim 21 wherein the crown volume is 80 to 100 percent filled with a hardenable composition.

25. A solid dental crown according to claim 21 wherein the crown volume is 90 to 100 percent filled with a hardenable composition.

26. A solid dental crown according to claim 21 wherein the crown volume is 95 to 100 percent filled with a hardenable composition.

27. A solid dental crown according to claim 21 wherein the hardenable composition comprises radiation curable material.

28. A solid dental crown according to claim 21 wherein the hardenable composition comprises:
a resin system comprising at least one ethylenically unsaturated component and a crystalline component;
greater than 60 wt-% of a filler system; and
an initiator system;
wherein the hardenable composition exhibits the sufficient malleability at a temperature of about 15° C. to 38° C.

29. A solid dental crown according to claim 21 wherein the hardenable composition does not adhere to the prepared tooth surface.

30. A solid dental crown according to claim 21 further comprising an adhesive disposed on the recess surface.

31. A method of using a self-supporting solid hardenable preformed dental crown comprising:
providing a self-supporting solid hardenable preformed dental crown having an external crown shape defined by an external crown surface, the external crown surface defining a crown volume being substantially filled with a hardenable composition;
pressing the self-supporting solid hardenable preformed dental crown onto a prepared tooth to form a recess in the solid preformed dental crown defined by a recess surface that is complimentary to the prepared tooth surface.

32. A method according to claim 31 further comprising coating an adhesive or cement layer onto the prepared tooth to form an adhesive coated prepared tooth, for bonding the self-supporting solid hardenable preformed dental crown onto the prepared tooth.

33. A method according to claim 31 further comprising curing the hardenable preformed dental crown to form a hardened dental crown.

34. A method according to claim 31 further comprising forming the external crown shape into an altered external crown shape after the pressing step.

35. A method according to claim 31 further comprising removing a portion of the hardenable composition before the pressing step.

36. A method according to claim 32 further comprising disposing the self-supporting solid hardenable preformed dental crown having the recess surface onto the adhesive coated prepared tooth.

37. A method according to claim 31 wherein the pressing step comprises pressing the self-supporting solid hardenable preformed dental crown onto a prepared tooth to form a recess in the solid preformed dental crown defined by a recess surface that is complimentary to the prepared tooth surface and the recess surface is in intimate contact with the prepared tooth surface.

38. A method according to claim 36 further comprising curing the hardenable preformed dental crown to form a hardened dental crown.

39. A method according to claim 31 wherein the providing step comprises providing a self-supporting solid hardenable preformed dental crown having an external crown shape defined by an external crown surface, the external crown surface defining a crown volume, the crown volume being 90 to 100 percent filled with a hardenable composition.

40. A method according to claim 31 wherein the providing step comprises providing a self-supporting solid hardenable preformed dental crown having an external crown shape defined by an external crown surface, the external crown surface defining a crown volume, the crown volume being 95 to 100 percent filled with a hardenable composition.
